(19) United States
(12) Patent Application Publication
(10) Pub. No.: US 2009/0249625 A1
(43) Pub. Date: Oct. 8, 2009

(54) METHOD FOR JOINTING A SEMICONDUCTOR ELEMENT AND A HEAT PIPE

(75) Inventors: CHIH-PENG HSU, HuKou (TW); CHUNG-MIN CHANG, HuKou (TW); CHIH-MING LAI, HuKou (TW); TSE-AN LEE, HuKou (TW)

Correspondence Address: PCE INDUSTRY, INC.;ATT. Steven Reiss, 288 SOUTH MAYO AVENUE, CITY OF INDUSTRY, CA, 91789, US

(73) Assignee: ADVANCED OPTOELECTRONIC TECHNOLOGY, INC., Hsinchu Hsien (TW)

(21) Appl. No.: 12/411,323

(22) Filed: Mar. 25, 2009

(30) Foreign Application Priority Data
Apr. 2, 2008 (CN) 200810300817.5

(51) Int. Cl. B23P 6/00

(52) U.S. Cl. 29/890.032

(57) ABSTRACT

An exemplary method for jointing a semiconductor element and a heat pipe includes: providing a heat pipe shell which has an open end; forming a capillary structure layer on an inner wall of the heat pipe shell; jointing a semiconductor element with the heat pipe shell by metal jointing; injecting a working fluid into the heat pipe shell and discharging air or gas from the heat pipe shell; and sealing the open end of the heat pipe shell.

### BACKGROUND

1. Technical Field

The present invention generally relates to a method for jointing a semiconductor element and a heat pipe.

2. Discussion of Related Art

Light emitting diodes (LEDs) are one kind of semiconductor element. Nowadays, LEDs are used extensively as light sources for illuminating devices, due to their high luminous efficiency, low power consumption and long work life. However, LEDs generate a significant amount of heat during use. Typically, heat pipes with working fluid filled therein are utilized to dissipate heat generated by LEDs. The LEDs are usually soldered onto such heat pipes. However, if a high temperature soldering process is required, the working fluid in the heat pipe may become excessively hot and vaporize. When this happens, the heat pipe is liable to be damaged due to the high pressure generated by the working fluid vapor.

Therefore, what is needed is a method for jointing a semiconductor element and a heat pipe, which method is capable of overcoming the above described shortcomings.

### BRIEF DESCRIPTION OF THE DRAWINGS

Many aspects of the present method for jointing a semiconductor element and a heat pipe can be better understood with reference to the following drawings. The components in the drawings are not necessarily drawn to scale, the emphasis instead being placed upon clearly illustrating the principles of the present method for jointing a semiconductor element and a heat pipe. Moreover, in the drawings, like reference numerals designate corresponding parts throughout certain views.

FIG. 1 is a flow chart of a method for jointing a semiconductor element and a heat pipe, according to a first exemplary embodiment.

FIG. 2 is a flow chart of a method for jointing a semiconductor element and a heat pipe, according to a second exemplary embodiment.

FIG. 3 is a flow chart of a method for jointing a semiconductor element and a heat pipe, according to a third exemplary embodiment.

FIG. 4 is an end plan view of a circuit board and a semiconductor element which are electrically jointed together according to the third exemplary embodiment.

FIG. 5 is an end plan view showing another circuit board and a semiconductor element which are electrically jointed together according to the third exemplary embodiment.

### DETAILED DESCRIPTION OF EMBODIMENTS

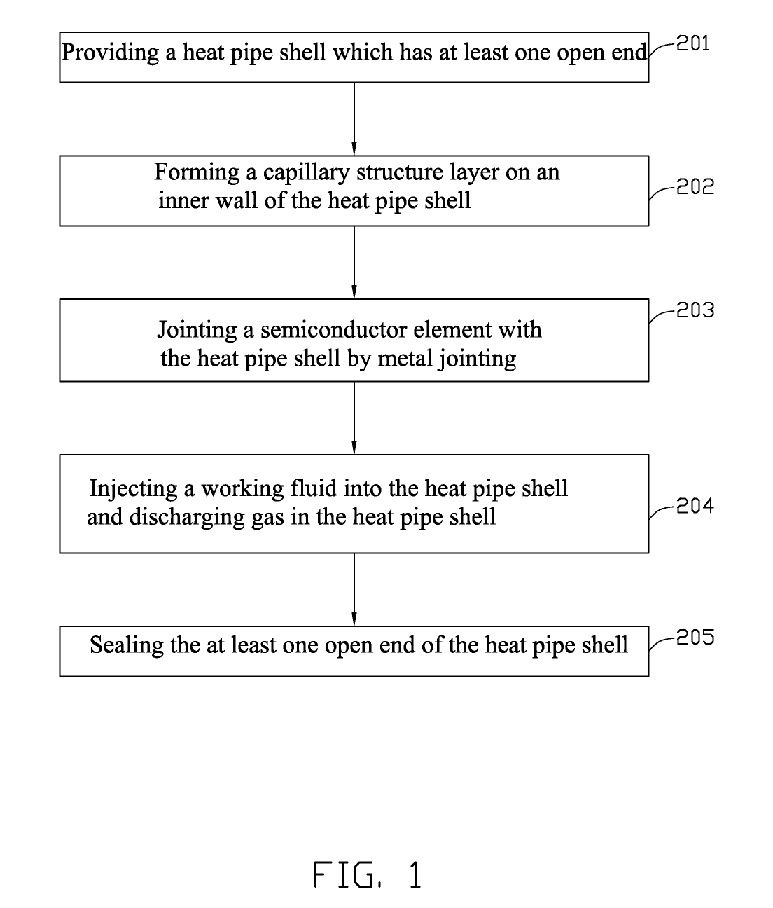

Reference will now be made to the drawings to describe embodiments of the present method for jointing a semiconductor element and a heat pipe, in detail. Referring to FIG. 1, a method for jointing a semiconductor element and a heat pipe, according to a first embodiment, includes:

Step 201: providing a heat pipe shell which has at least one open end;

Step 202: forming a capillary structure layer on an inner wall of the heat pipe shell;

Step 203: jointing a semiconductor element with the heat pipe shell by metal jointing;

Step 204: injecting a working fluid into the heat pipe shell and discharging air or gas from the heat pipe shell; and

Step 205: sealing the at least one open end of the heat pipe shell.

Referring to step 201, the heat pipe shell is for example a hollow tube. The heat pipe shell can be made of metal or alloy having a high heat transfer coefficient, such as copper, silver, aluminum, gold, and any suitable alloy thereof.

Referring to step 202, the capillary structure layer can be made from metal powder or metal alloy powder. The capillary structure layer can also be made from fiber (for example carbonic fiber), capillary tubes, porous silicon oxide, or bibulous ceramic. Step 202 typically further includes the following steps: disposing capillary structure material on the inner wall of the heat pipe shell; and sintering the capillary structure material. As such, the capillary structure layer is formed on the inner wall of the heat pipe shell. In an alternative embodiment, step 201 and step 202 can be combined as a single step of “providing a heat pipe shell which has at least one open end, and which also has a capillary structure layer on an inner wall thereof.” In another alternative embodiment, step 201 and step 202 can be simplified as a single step of “providing a heat pipe shell which has at least one open end.”

Referring to step 203, the metal jointing is eutectic bonding, surface mounting, or spot welding.

Referring to step 204, the working fluid can be water, alcohol, ketone, another inorganic compound, or another organic compound. The sub-step of “injecting a working fluid into the heat pipe shell” can be executed before, during, or after the sub-step of “discharging air or gas from the heat pipe shell,” due to different properties of various working fluids. The air or gas in the heat pipe shell can be discharged by heat exhaustion, vacuum exhaustion, redox exhaustion, or osmosis exhaustion.

Referring to step 205, the heat pipe shell can be sealed by welding, such as braze welding.

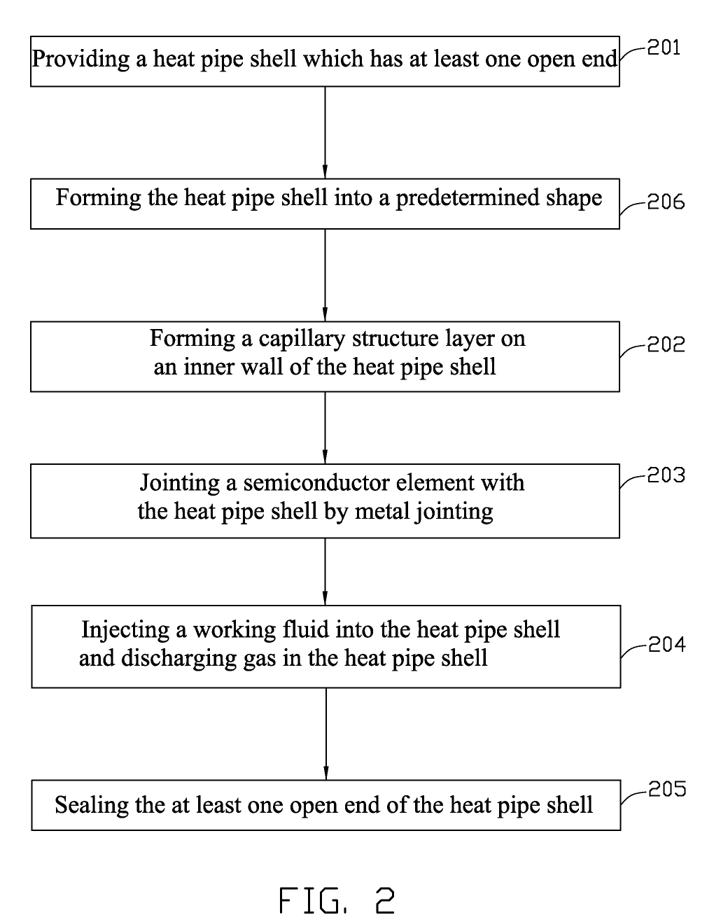

Referring to FIG. 2, in a second embodiment, a further step 206 can be executed before step 202 of the first embodiment. Step 206 is forming the heat pipe shell into a predetermined shape. The heat pipe shell can be formed into any of various kinds of desired shapes, such as a U shape, by mechanical processing. At least one flat plane can also be formed on the outer wall of the heat pipe shell by mechanical processing. The at least one flat plane is adapted to contact semiconductor components, which usually have flat jointing surfaces. In an alternative embodiment, step 206 can be executed after step 203. A shaft can be inserted into the interior of the heat pipe shell to support the capillary structure layer during the mechanical processing, thereby preventing the capillary structure layer from being deformed or collapsing under exterior force. After the mechanical processing is completed, the shaft can be removed.

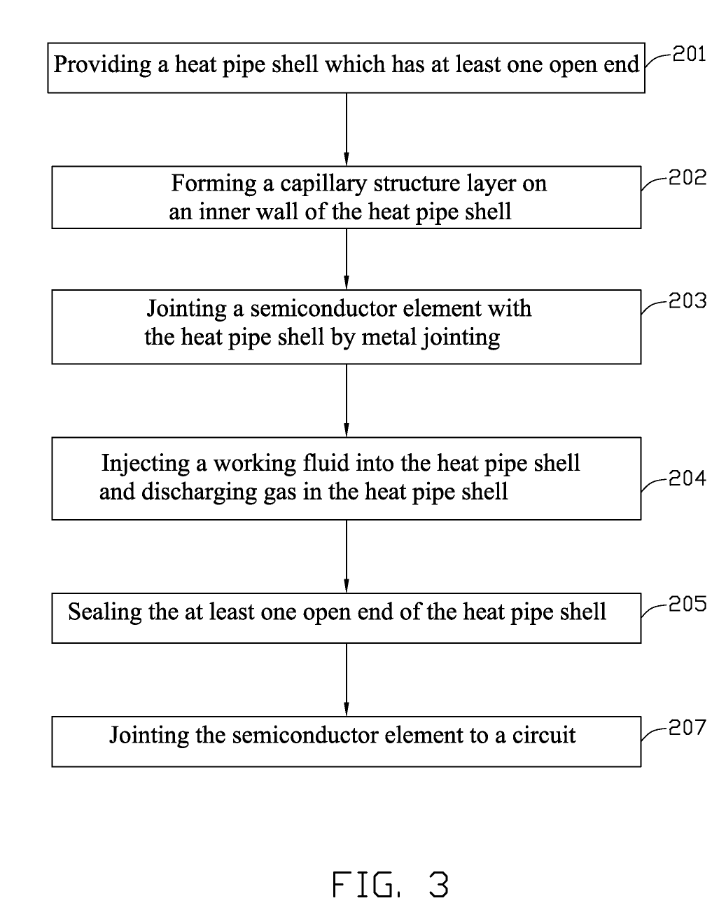

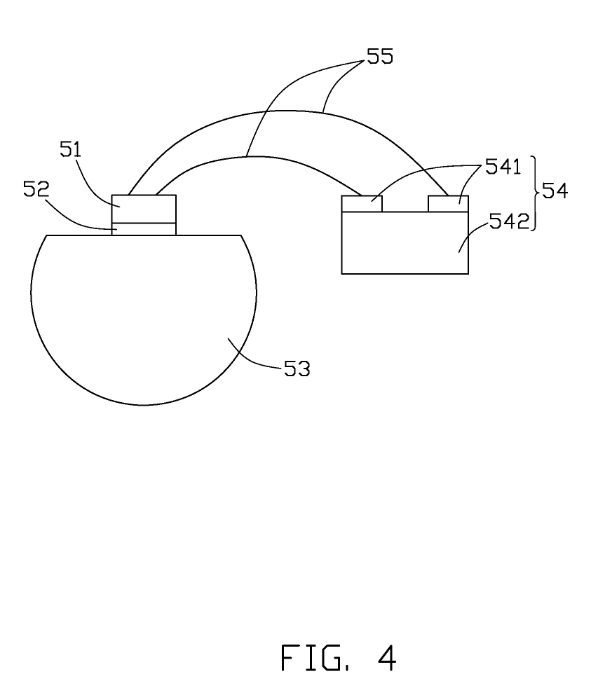

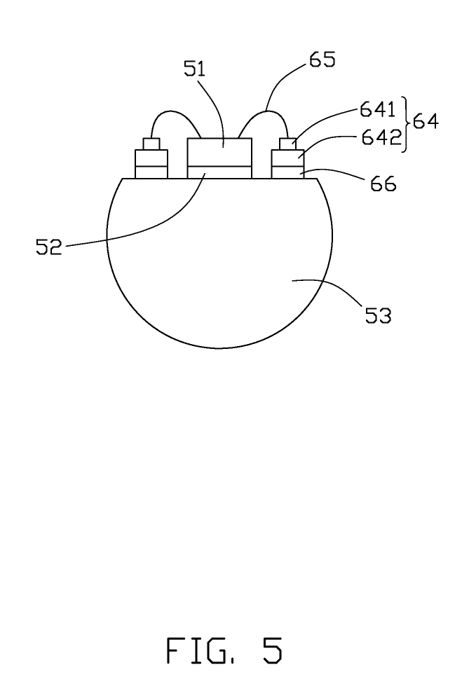

Referring to FIG. 3, in a third embodiment, a further step 207 can be executed after step 205 of the first embodiment. Step 207 is jointing the semiconductor element to a circuit. Two possible positional relationships of the sealed heat pipe and a circuit board are respectively illustrated in FIG. 4 and FIG. 5.

Referring to FIG. 4, a circuit board 54 and a heat pipe 53 are spaced apart from each other. A semiconductor element 51 is jointed to the heat pipe 53 by a metallic joint 52. The circuit board 54 includes an electrically conductive layer 541 and an electrically insulating layer 542. The electrically conductive layer 541 is electrically connected to the semiconductor element 51 by wires 55. The circuit board 54 can be a printed circuit board, such as a metal core printed circuit board. The electrically insulating layer 542 can be made of insulating material such as resin or rubber. The metallic joint 52 is made of material with high thermal conductivity, such as tin solder.

Referring to FIG. 5, at least one circuit board 64 is disposed on a flat outer wall of the heat pipe 53. The semiconductor element 51 is jointed to the heat pipe 53 by the metallic joint 52. The circuit board 64 includes an electrically conductive layer 641 and an electrically insulating layer 642. The electrically conductive layer 641 is electrically connected to the semiconductor element 51 by a wire 65. The electrically insulating layer 642 is connected to the outer wall of the heat pipe 53 by a joint material 66 such as heat conductive glue or tin solder.

The semiconductor element 51 can for example be a light emitting diode (LED), an LED chip, an LED wafer, a laser diode, a high power electrical element, a high frequency electrical element, an integrated circuit, or an integrated circuit chip.

Although the heat pipe 53 illustrated in FIG. 4 and FIG. 5 has a single flat outer wall, the heat pipe 53 can instead have other suitable configurations. For example, the heat pipe 53 can have a cylindrical outer wall, or two or more flat outer walls.

In the above-described embodiments, the heat pipe shell is heated for jointing before the working fluid is injected into the heat pipe shell. Therefore there is little or no risk of the working fluid in the heat pipe becoming excessively hot, vaporizing, and causing damage to the heat pipe.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A method for jointing a semiconductor element and a heat pipe, the method comprising:
providing a heat pipe shell which has at least one open end;
forming a capillary structure layer on an inner wall of the heat pipe shell;
jointing a semiconductor element with the heat pipe shell by metal jointing;
injecting a working fluid into the heat pipe shell and discharging air or gas from the heat pipe shell; and
sealing the at least one open end of the heat pipe shell.

2. The method for jointing a semiconductor element and a heat pipe according to claim 1, wherein the metal jointing is selected from the group consisting of eutectic bonding, surface mounting, and spot welding.

3. The method for jointing a semiconductor element and a heat pipe according to claim 1, wherein discharging air or gas from the heat pipe shell is performed using a method selected from the group consisting of heat exhaustion, vacuum exhaustion, redox exhaustion, and osmosis exhaustion.

4. The method for jointing a semiconductor element and a heat pipe according to claim 1, further comprising forming the heat pipe shell into a predetermined shape before forming a capillary structure layer on an inner wall of the heat pipe shell.

5. The method for jointing a semiconductor element and a heat pipe according to claim 1, further comprising forming the heat pipe shell into a predetermined shape after forming a capillary structure layer on an inner wall of the heat pipe shell and before jointing a semiconductor element with the heat pipe shell by metal jointing.

6. The method for jointing a semiconductor element and a heat pipe according to claim 1, further comprising jointing the semiconductor element and a circuit board after sealing the at least one open end of the heat pipe shell.

7. The method for jointing a semiconductor element and a heat pipe according to claim 1, wherein the semiconductor element is selected from the group consisting of a light emitting diode, a light emitting diode chip, a light emitting diode wafer, a laser diode, a high power electrical element, a high frequency electrical element, an integrated circuit, and an integrated circuit chip.

8. A method for jointing a semiconductor element and a heat pipe, the method comprising:
providing a heat pipe shell which has at least one open end;
jointing a semiconductor element with the heat pipe shell by metal jointing;
injecting a working fluid into the heat pipe shell and discharging air or gas from the heat pipe shell; and
sealing the at least one open end of the heat pipe shell.

9. The method for jointing a semiconductor element and a heat pipe according to claim 8, wherein the metal jointing is selected from the group consisting of eutectic bonding, surface mounting, and spot welding.

10. The method for jointing a semiconductor element and a heat pipe according to claim 8, wherein discharging air or gas from the heat pipe shell is performed using a method selected from the group consisting of heat exhaustion, vacuum exhaustion, redox exhaustion, and osmosis exhaustion.

11. The method for jointing a semiconductor element and a heat pipe according to claim 8, further comprising forming the heat pipe shell into a predetermined shape before jointing a semiconductor element with the heat pipe shell by metal jointing.

12. The method for jointing a semiconductor element and a heat pipe according to claim 8, further comprising jointing the semiconductor element and a circuit board after sealing the at least one open end of the heat pipe shell.

13. The method for jointing a semiconductor element and a heat pipe according to claim 8, wherein the semiconductor element is selected from the group consisting of a light emitting diode, a light emitting diode chip, a light emitting diode wafer, a laser diode, a high power electrical element, a high frequency electrical element, an integrated circuit, and an integrated circuit chip.

14. A method for jointing a semiconductor element and a heat pipe, the method comprising:
providing a heat pipe shell which has at least one open end, and which also has a capillary structure layer on an inner wall thereof;
jointing a semiconductor element with the heat pipe shell by metal jointing;
injecting a working fluid into the heat pipe shell and discharging air or gas from the heat pipe shell; and
sealing the at least one open end of the heat pipe shell.

15. The method for jointing a semiconductor element and a heat pipe according to claim 14, wherein the metal jointing is selected from the group consisting of eutectic bonding, surface mounting, and spot welding.

16. The method for jointing a semiconductor element and a heat pipe according to claim 14, wherein discharging air or gas from the heat pipe shell is performed using a method selected from the group consisting of heat exhaustion, vacuum exhaustion, redox exhaustion, and osmosis exhaustion.

17. The method for jointing a semiconductor element and a heat pipe according to claim 14, further comprising forming the heat pipe shell into a predetermined shape before jointing a semiconductor element with the heat pipe shell by metal jointing.

18. The method for jointing a semiconductor element and a heat pipe according to claim 14, further comprising jointing the semiconductor element and a circuit board after sealing the at least one open end of the heat pipe shell.

19. The method for jointing a semiconductor element and a heat pipe according to claim 14, wherein the semiconductor element is selected from the group consisting of a light emitting diode, a light emitting diode chip, a light emitting diode wafer, a laser diode, a high power electrical element, a high frequency electrical element, an integrated circuit, and an integrated circuit chip.
